(19) United States
(12) Patent Application Publication
(10) Pub. No.: US 2013/0219043 A1
(43) Pub. Date: Aug. 22, 2013

(54) METHOD AND APPARATUS FOR AUTOMATIC MIGRATION OF APPLICATION SERVICE

(71) Applicants: Moritz M. Steiner, Montclair, NJ (US); Krishna P. Puttaswamy Naga, Metuchen, NJ (US)

(72) Inventors: Moritz M. Steiner, Montclair, NJ (US); Krishna P. Puttaswamy Naga, Metuchen, NJ (US)

(21) Appl. No.: 13/400,377

(22) Filed: Feb. 20, 2012

(51) Int. Cl. G06F 15/173

(52) U.S. Cl. 709/224

(57) ABSTRACT

A method and apparatus for dynamically migrating a virtual desktop (VD) user from a first data center (DC) to a second DC in response to a determination made using DC management information and communications network management information that a user quality of experience (QoE) is deficient.

### FIELD OF THE INVENTION

The invention relates generally to communication networks and, more specifically but not exclusively, to dynamic virtual desktop.

### BACKGROUND

“Desktop as a service” is a virtual desktop application hosted at a data center (DC). The user connects to this virtual desktop using a protocol such as “windows rdp” or “vnc”. The desktop as a service application, as well as other virtual or hosted applications, relies upon the availability of the DC hosting the virtual desktop and the network connecting to the DC. There are several potential problems with this arrangement: 1) the DC, or a part of it, fails or becomes overloaded; 2) the network path to the DC fails or becomes overloaded; 3) or the user travels and the network distance between the user and the virtual desktop is too long. For example, a user based on the East Coast (NY) experiences different latency connecting to a DC in Virginia compared to a virtual desktop that is hosted in Europe or on the West Coast or Japan. Only the first case allows the user to work in a productive way, all other locations of the virtual desktop negatively impact the user experience.

As the number of hosted application sessions such as virtual desktops (VDs) increases, the load on the network created by the users connecting to their VDs increases network congestion close to the DCs hosting the VDs. The DC or the network between the user and the DC may become unavailable or overloaded.

### SUMMARY

Various deficiencies in the prior art are addressed by embodiments for dynamically migrating a virtual desktop (VD) user from a first data center (DC) to a second DC in response to a determination made using DC management information and communications network management information that a user quality of experience (QoE) is deficient.

In one embodiment, a method, system and/or apparatus is provided for managing application services sessions for data center (DC) hosted applications provided to one or more user via a communications network, comprising determining, using DC management information and communications network management information, whether a user quality of experience (QoE) associated with the application services session is below a threshold level; and in the case of the QoE being below the threshold level, selecting a new DC and migrating the application services session of at least one user to the new DC.

### BRIEF DESCRIPTION OF THE DRAWINGS

The teachings herein may be readily understood by considering the following detailed description in conjunction with the accompanying drawings, in which:

FIG. 1 depicts a high-level block diagram of a system including an exemplary Application Agreement Center benefiting from an embodiment;

FIG. 2 depicts a flow diagram of a Quality of Experience (QoE) method for migrating a user session according to an embodiment;

FIG. 3 depicts one embodiment of the method of FIG. 2;

FIG. 4 depicts an exemplary use of the Application Agreement Center Server of FIG. 1 to perform event correlation and determine reactive/predictive control information; and

FIG. 5 depicts a high-level block diagram of a computing device suitable for use in implementing various functions described herein.

To facilitate understanding, identical reference numerals have been used, where possible, to designate identical elements that are common to the figures.

### DETAILED DESCRIPTION

Generally speaking, various embodiments discussed herein provide a function to dynamically migrate a virtual desktop (VD) user from a first data center (DC) to a second DC proximate the user. Thus, while primarily described within the context of a function facilitating the transfer of user files from one data center to the next, it will be appreciated by those skilled in the art that the invention is applicable to various migration arrangements.

One embodiment involves detecting or determining dynamic network conditions and data center conditions and responsively migrating user sessions from an overburdened data center to a less burdened data center. The virtual desktop session may be migrated to a data center close to the user, accessible to the user via a higher bandwidth link, accessible to the user via a specific link (such as a corporate or secure link), accessible to the user according to a quality of service defined by service level agreement and so on. The speed of session migration is improved in various embodiments based on observing the users' access pattern and learning which data blocks are most used by the users. For example, in a virtual desktop session, only a subset of a total amount of files is typically needed by the user. Thus, migration of a virtual desktop session may include preferentially migrating the identified necessary subset of files alone or prior to other files.

Based on multiple input parameters such as the user location, the network dynamics, the datacenter load, a decision is made where to run the virtual desktop of the user, i.e., the most efficient location to run the virtual desktop of the user. If the user travels, the virtual desktop (VD) is going to be migrated to a new location proximate to the user. If the link between the user and the DC running the VD gets overloaded, the VD is going to be migrated to another DC. Also, network load can be steered at an application level. If a link to a DC hosting many VDs gets overloaded, these VDs can be migrated to another DC, improving the user experience and decongesting the link to the old datacenter.

In addition to adapting to the network's dynamics, the migration speed is improved by leveraging the fact that only a small amount of the total data in the VD is actually used by the users. For example, it is reported that in a week, only about 20% of the total data blocks in the disk are used by the users. Even among this 20%, only a small fraction accounts for most of the accesses from the users. This implies that by migrating the most used blocks (which is much less than 20% of the disk) the users may experience a good virtual desktop session. This may easily lead to a 5 times increased speed of migration.

In one embodiment, this migration process is made proactive. Based on the previous observation, the most-used blocks are proactively replicated to all the data centers periodically (end of each day). The cost of this process is insignificant in terms of storage and bandwidth compared to the advantages derived therefrom. The user is able to quickly switch to a different data center without any appreciable migration downtime.

Illustratively, a user works for a company in New Jersey on the US East Coast. The user's VD is being hosted in a DC in Virginia. Latency between the user and the VD approximates 20 ms; the user experience is the same as working on a local machine. The same user travels to Paris, France. The latency of the user's VD now approximates 90 ms; the user's service is degraded significantly reducing the user's productivity. To address this problem, in various embodiments, the user's VD is automatically migrated to a datacenter in Europe, bringing the network latency to an acceptable level, thereby providing a satisfactory experience to the user.

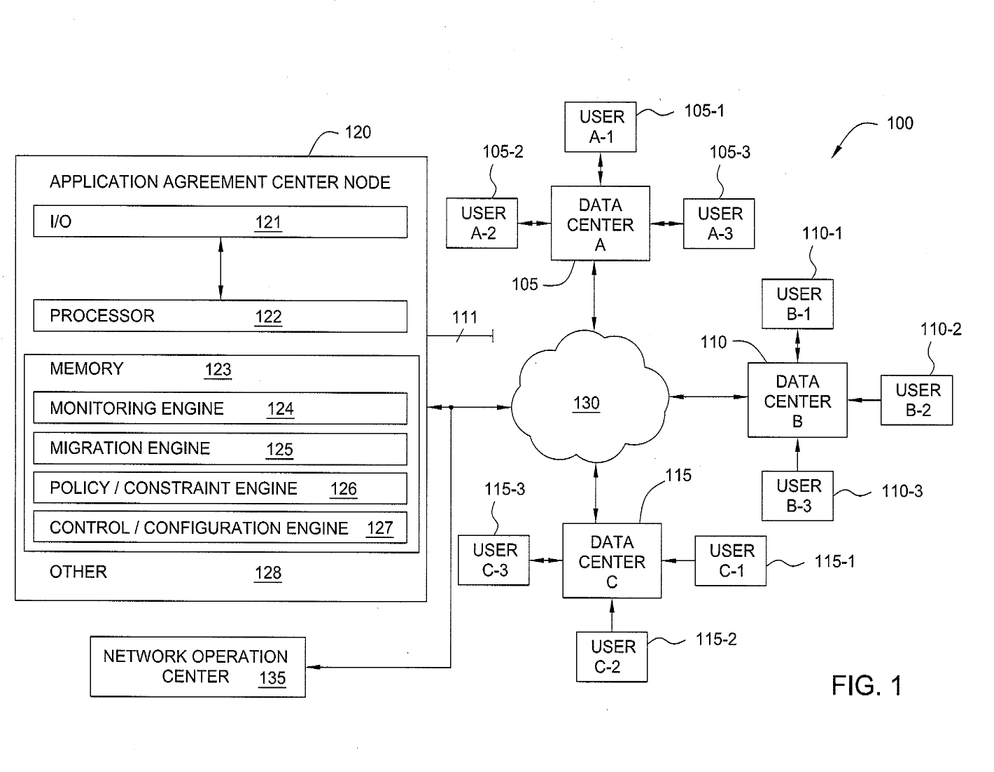

FIG. 1 depicts a high-level block diagram of a system including an exemplary Application Agreement Center Node benefiting from an embodiment.

As depicted in FIG. 1, system 100 includes Data Center (DC) 105 and associated users 105-1, 105-2 and 105-3, Data Center (DC) 110 and associated users 110-1, 110-2 and 110-3, Data Center (DC) 115 and associated users 115-1, 115-2 and 115-3, network 130, Application Agreement Center Node 120 and Network Operation Center 135.

In one embodiment, Data Center 105, 110, 115 and Network Operation Center 135 are owned by the same entity. In another embodiment, Data Center 105, 110, 115 and Network Operation Center 135 are owned by different entities.

In one embodiment, network 110 includes IPv4, IPv6 and the like. In another embodiment, network 110 includes cloud computing. In general, cloud computing enables high scalability, configurability, elasticity of resource availability on a dynamic basis, ease of return, and like advantages. Cloud computing provides extensive capability for hardware provisioning to create an appearance of “infinite” computing resources available on demand, quickly enough to follow load surges, thereby eliminating the need for advance provisioning. Cloud computing, given its ease of sizing, enables implementation of less expensive failover solutions, because of the on-demand or pay-as-you go nature of cloud services. In cloud computing, the customer pays for use of computing resources on a short term basis as needed (e.g. processors by the hour, storage by the day, and the like), and may request and release them as needed. Cloud computing also allows for economies of scale (e.g., factors of improvement in electricity, net bandwidth, operations, software and hardware, and the like), permits statistical multiplexing to increase resource utilization, and simplifies operations. Various other advantages of cloud computing also will be appreciated.

While primarily described within the context of a specific network facilitating traffic flows between one or more end-hosts associated with an Internet Protocol (IP) or cloud computing, it will be appreciated by those skilled in the art that the invention is applicable to various networks.

The exemplary Application Agreement Center Node 120 may support one or more of virtual desktop migration functions, and other functions within a wired or wireless network environment. Exemplary Application Agreement Center Server 120 is representative of one or more of a plurality of routing/switching elements within a communication system including a plurality of routing/switching elements of various types.

The exemplary Application Agreement Center Node 120 includes a network interface 111 via which the exemplary router may communicate with other devices, which may include peer and non-peer devices. Although depicted as having a single network interface 111, it will be appreciated that exemplary Application Agreement Center Node 120 may include any suitable number of network interfaces.

Generally speaking, the Application Agreement Center Node 120 receives input traffic data from various input ports (not shown) from one or more prior network elements. The Application Agreement Center Node 120 utilizes a switch fabric to route the input traffic data toward various output ports (not shown) for transmission toward next network elements.

Generally speaking, the exemplary Application Agreement Center Node 120 is configured for supporting communication between DC 105, 110, 115 and Application Agreement Center Node 120 via networks 130 to adapt the operation of the DC and/or the elements associated with the DC.

As depicted in FIG. 1, exemplary Application Agreement Center Server 120 includes I/O circuitry 121, a processor 122, and a memory 123. Processor 122 is adapted to cooperate with memory 123, I/O circuitry 121 and one or more communication interfaces to provide various virtual desktop migration functions for the users.

I/O circuitry 121 is adapted to facilitate communications with peripheral devices both internal and external to processor 122. For example, I/O circuitry 121 is adapted to interface with memory 123. Similarly, I/O circuitry 121 is adapted to facilitate communications with Monitoring Engine (ME) 124, Migration Engine 125, Policy/Constraint Engine 126, Control/Configuration Engine (CE) 127 and the like. In various embodiments, a connection is provided between processor ports and any peripheral devices used to communicate with a host.

Although primarily depicted and described with respect to Monitoring Engine (ME) 124, Migration Engine 125, Policy/Constraint Engine 126, Control/Configuration Engine (CE) 127, it will be appreciated that I/O circuitry 121 may be adapted to support communications with any other devices suitable for providing the computing services associated with the relay content herein described.

Memory 123, generally speaking, stores data and software programs that are adapted for use in providing various computing functions within the communication system. The memory includes Monitoring Engine (ME) 124, Migration Engine 125, Policy/Constraint Engine 126, Control/Configuration Engine (CE) 127 and Other Control Programs 128.

In one embodiment, Monitoring Engine (ME) 124 is implemented using software instructions which may be executed by processor (e.g., controller 122) for performing the various functionalities depicted and described herein.

Although depicted and described with respect to an embodiment in which each of the engines is stored within memory 123, it will be appreciated by those skilled in the art that the engines may be stored in one or more other storage devices internal to Application Agreement Center Server 120 and/or external to Application Agreement Center Server 120. The engines may be distributed across any suitable numbers and/or types of storage devices internal and/or external to Application Agreement Center Server 120. Memory 123, including each of the engines and tools of memory 123, is described in additional detail herein below.

As described herein, memory 123 includes Monitoring Engine (ME) 124, which cooperates to provide the various virtual desktop monitoring functions depicted and described herein. Although primarily depicted and described herein with respect to specific functions being performed by and/or using specific ones of the engines of memory 123, it will be appreciated that any of the virtual desktop monitoring functions depicted and described herein may be performed by and/or using any one or more of the engines of memory 123.

In various embodiments, Monitoring Engine (ME) 124 performs monitoring and metering functions for automatic migration system 100.

ME 124 may be configured to periodically scan the computing resources in automatic migration system 100 to identify faults, identify security attacks, measure the performance of the application, and the like, and, further, to report associated results (e.g., identification of faults, identification of security attacks, detection of performance degradation, and the like, as well as various combinations thereof).

ME 124 may be configured to generate alerts when aberrations are detected, and related alerts are correlated and analyzed to determine the existence (or non-existence) of service affecting network conditions.

ME 124 may be configured to collect alarms (e.g., from some or all of the network components of automatic migration system 100) and to correlate the collected alarms against the alert conditions based on temporal and/or spatial relativity.

ME 124 may be configured to gather network topology information for the automatic migration system 100 and to incorporate the network topology information into one or more models for use in performing such correlation functions.

ME 124 may be configured to determine the root cause of independent network events and, optionally, to mark detected network events as outage-related (service affecting) or non-outage-related (non-service affecting).

ME 124 may be configured to calculate service availability for a specific aggregation level over a specific period of time by analyzing the set of independent root cause events to determine the set falling within the specified time period, combining the durations of the correlated events to calculate the total amount of outage time within the specified time period, comparing the events against the network topology information and the types of services affected by the events, and determining a total service availability for the service(s) being evaluated using the scope of network impact and the percentage of outage time. It is noted that determination of service availability may be dependent on the sub-network(s) considered, the underlying network technologies used, network topology/size, and like factors.

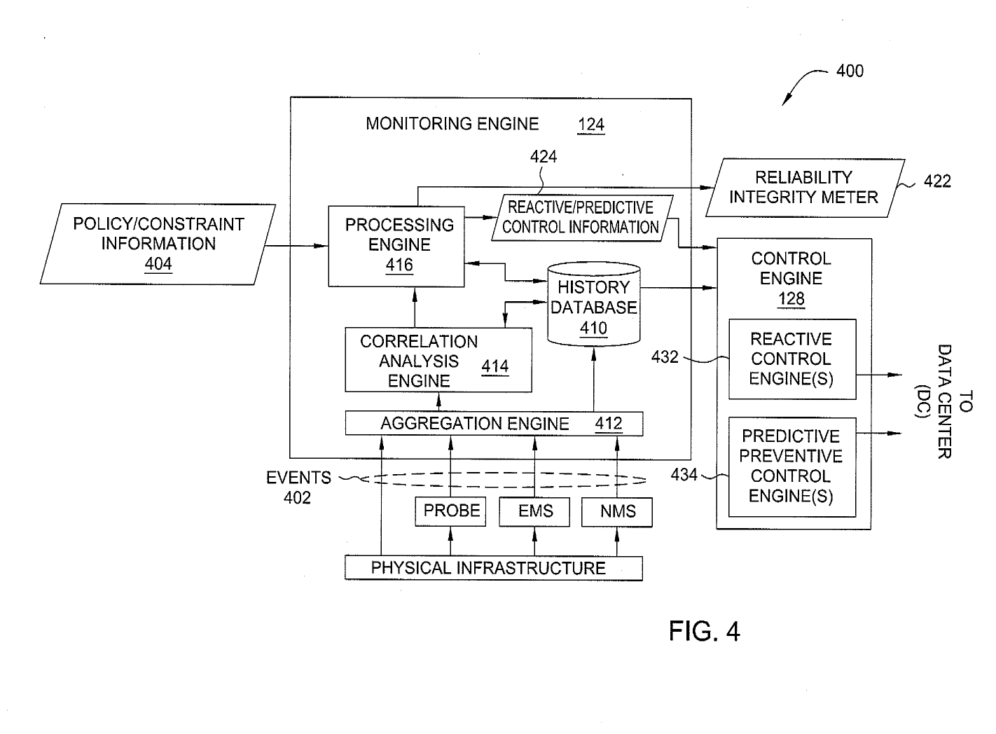

ME 124 may be configured to determine a Reliability Integrity Meter and to determine control information for use by CE 127. An exemplary use of ME 124 to perform such functions is depicted and described with respect to FIG. 4.

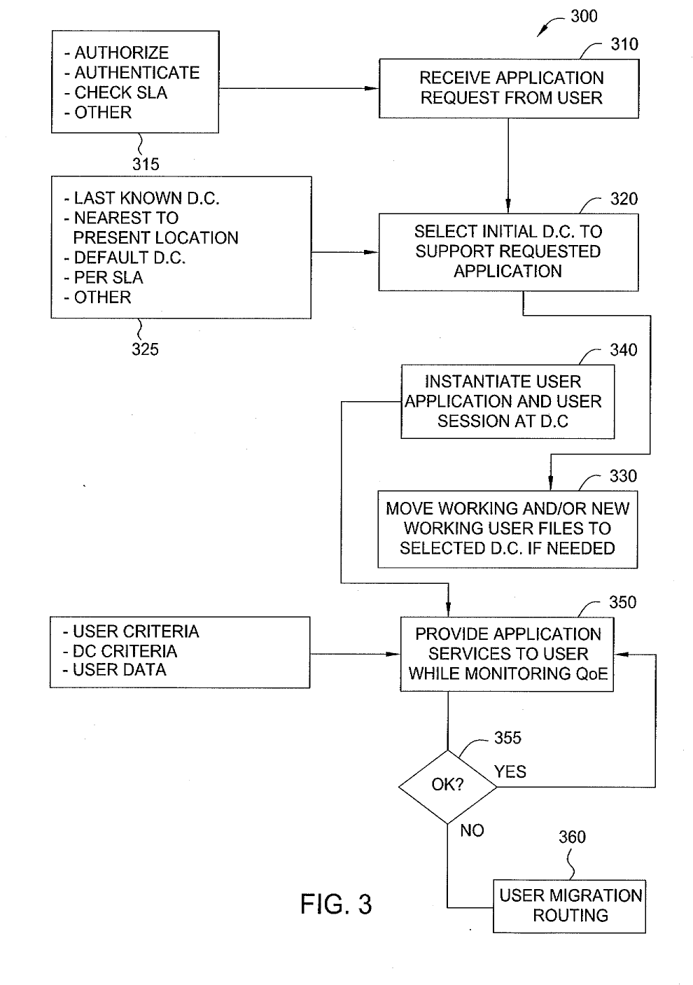

Migration Engine 125 automatically migrates the user as described with respect to FIG. 3.

The Policy/Constraint Engine 126 may include one or more of hardware and/or software resource usage information, customer profile information, required performance information, security constraints, cost constraints, and the like, as well as various combinations thereof. Policy/constraint output is used by ME 124.

Control/configuration Engine (CE) 127 dynamically generates a virtual configuration for the user. The virtual configuration specifies a virtual configuration for the customer that satisfies the SLA of the customer (e.g., satisfying the requirements and/or goals of the SLA). The virtual configuration may be specified as a function of time. The CE 127 may dynamically generate the virtual configuration that satisfies the SLA while also accounting for the current state of automatic migration system 100 and/or policies/constraints imposed by the automatic migration system 100. CE 127 derives critical end-to-end service availability metrics from available network and service data and triggers appropriate recovery and control actions; provides preventive control capabilities that enable generation of indications of impending issues and proactive in-service testing to constantly detect and troubleshoot critical problems; and the like. The CE 127 may provide various other functions as discussed herein.

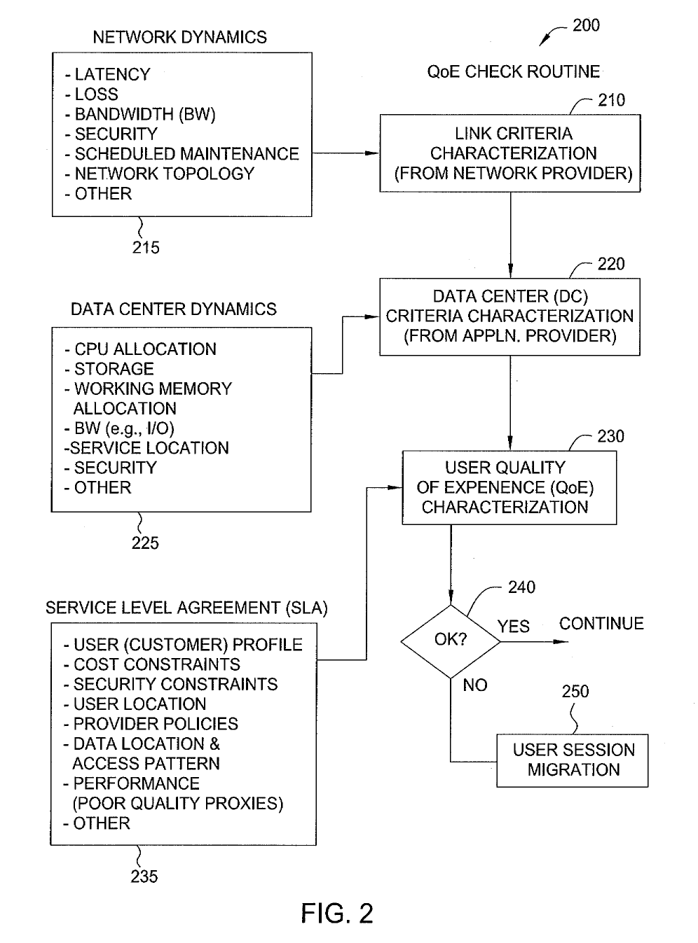

FIG. 2 depicts a flow diagram of a Quality of Experience (QoE) method for migrating a user session according to an embodiment. The embodiment of the method 200 of FIG. 2 contemplates a user communicating with a DC via network 130. As noted herein, an Application Agreement Center Node or functionality may be included within a router to provide the automatic migration functions described herein.

As depicted in FIG. 2, input information is received and used at certain points in method 200. The input information includes Network Dynamics 215, Data Center Dynamics 225 and Service Level Agreement (SLA) 235. The SLA includes customer application topology information of the customer (e.g., which may be specified explicitly and/or extracted from a description), customer SLA information of the customer policy/constraint information (e.g., one or more of hardware and/or software resource usage information, customer profile information, required performance information, security constraints, cost constraints, and so forth) and the like. Network Dynamics information 215 includes latency information, loss, bandwidth (BW), security information, congestion information, scheduled maintenance, network topology and the like. Data Center Dynamics information 225 includes CPU allocation (e.g., percentage of CPU allocated), storage, working memory allocation, BW (e.g., I/O), Service Location, Security and the like.

At step 210, link criteria characterization is generated using at least a portion of Network Dynamics information 215. In one embodiment, the link criteria characterization may be generated using the latency information, the security information, and the scheduled maintenance information.

At step 220, Data Center (DC) criteria characterization is generated using at least a portion of Data Center Dynamics information 225. In one embodiment, the DC criteria characterization may be generated using the CPU allocation information, the service location information, the security information, and the like.

At step 230, user Quality of Experience (QoE) characterization is generated using at least a portion of SLA information 235. In one embodiment, the SLA characterization may be generated using the customer profile information, the cost constraints information, the user location information, and the like.

At step 240, a decision to migrate the user session is made. The no branch of the decision is executed if the user QoE (step 230) so warrants. Otherwise, the process continues.

At step 250, the user session migration routine is executed.

FIG. 3 depicts one embodiment of the method of FIG. 2.

In general, process 300 performs a constrained mapping of what is needed and/or desired by the customer to what is realizable within the underlying infrastructure (i.e., it is as if the customer can dial-a-migration and the automatic migration system 100 attempts to deliver it).

At step 310, a user requests the creation of a virtual desktop (VD). This step is performed using at least a portion of information 315. In one embodiment, authorization information, authentication information and SLA information is obtained.

At step 320, the management of the VD service determines (by using the IP address of the user) that the user is located in New Jersey. A VD is created in the DC closest to the user, in Virginia on IP address IPv. A service name, such as userA.vd.com (pointing to IPv) is returned to user A. This step is performed using at least a portion of information 325. In one embodiment, the last known DC information is obtained.

At step 330, the relevant files are transferred to the selected DC. In one embodiment, the working file set is transferred. In another embodiment, both the working and non-working file sets are transferred.

At step 340, the user connects to userA.vd.com from New Jersey. The user application and user session are instantiated at the data center. Each application has its own requirement. For example, video has different requirements than audio. In one embodiment, a running copy of the session is kept at another data center.

At step 350, the service resolves the IP address of the user, and realized the user is still in New Jersey. Closest DC is still Virginia. The service returns the IP address IPv of the VD. The user connects to IPv and works. In one embodiment, the user moves from the initial location and illustratively travels to Paris, France. The user connects to userA.vd.com.

At step 355, the service resolves the IP address of the user, and determined that the user is in Paris, France. The closest DC is in Dublin, Ireland. A decision is made to migrate the user session.

At step 360, the service migrates the VD of the user to Dublin on IP address IPd. (Note that for resiliency reasons, or because the user has been in Europe before some version of the user's VD already exists in Paris. In this only the delta between the latest version in Virginia and the version in Dublin have to be transferred). The service returns the IP address IPd to the user. The user connects to the instantiated VD on IPd and seamlessly resumes the session of step 340. The user's experience is not frustrating because the maximum acceptable latency is adequate and the user's productivity is not adversely affected. In another embodiment, the user requests to be migrated to a different DC. In yet another embodiment, the user requests to be migrated to a specific DC.

In one embodiment, the system is configured to be proactive. The cost of this process is insignificant in terms of storage and bandwidth compared to the advantages derived therefrom. The user is able to quickly switch to a different data center without any appreciable migration downtime. The active data blocks to all the data centers the user might use are automatically replicated. In another embodiment, active data blocks to all the data centers the user has used in the past are automatically replicated.

Further, if the user were using a laptop, which for example, was stolen or destroyed for any reason, the user could use any replacement machine to connect to the VD.

As described earlier, virtual desktop technology comes with many advantages. Currently, the lack of dynamics in the placement of the VDs results in poor quality of experience (QoE) for the end-user, thus “desktop as a service” offering is impracticable.

So far VD desktop offerings have no built-in dynamics for the migration of the VD to a new location in case of degraded user experience (the user is traveling, a link is congested, etc). The various embodiments disclosed herein would allow for better quality of experience by migrating the VD using the many input parameters described herein. The various embodiments also allow for application level traffic steering.

FIG. 4 depicts an exemplary use of the Application Agreement Center Server of FIG. 1 to perform event correlation and determine reactive/predictive control information.

In general, process 400 performs a constrained mapping of what is needed and/or desired by the customer to what is realizable within the underlying virtual desktop migration infrastructure (i.e., it is as if the customer 102 can dial-a-migration and the virtual desktop migration system 100 attempts to deliver it).

In one embodiment, method 400 is executed by CE 127 of the Application Agreement Center Node 120.

As depicted in FIG. 4, input information is received and used at certain points in method 400. The input information includes customer application information 235, Network Dynamics 215 and Data Center Dynamics information 225. The customer application information 235 includes customer application topology information of the customer (e.g., which may be specified explicitly and/or extracted from a description), customer SLA information of the customer, policy/constraint information (e.g., one or more of hardware and/or software resource usage information, customer profile information, required performance information, security constraints, cost constraints, and so forth), and the like.

As depicted in FIG. 4, ME 124 is configured to perform event correlation/aggregation and determine reactive/predictive control information.

ME 124 receives events 402 and policy/constraint information 404. The events 402, as depicted in FIG. 4, may be received directly from the physical infrastructure (Network Dynamics, Data Center Dynamics) of automatic migration system 100 and/or may be received from other one or more monitoring and/or management elements/systems (e.g., one or more probes, one or more Element Management Systems (EMSs), one or more Network Management Systems (NMSs), and the like) on behalf of the physical infrastructure automatic migration system 100. The monitoring for the events 402 may be performed by ME 124 and/or across the physical infrastructure automatic migration system 100 (e.g., for reporting to ME 124). The types of events 402 for which monitoring is performed may include software alerts generated by subsystems, threshold crossings that occur in the measurement counters for various metrics, application failures (e.g., total and/or partial), security attacks that result in service being impacted, hardware failures (e.g., recoverable or not), variations in the traffic load, network failures, and the like. The policy/constraint information 404, as depicted in FIG. 4, may include one or more of hardware and/or software resource usage information, customer profile information, required performance information, security constraints, cost constraints, and the like, as well as various combinations thereof.

ME 124 includes an aggregation engine 412, a correlation analysis engine 414, and a processing engine 416. ME 124 also includes a history database 419.

The aggregation engine 412 receives the events 402 associated with the physical infrastructure and aggregates the events 402. The aggregation engine 412, when performing processing for a specific period of time, may aggregate the events 402 by analyzing the events 402 to determine the set falling within the specified time period. The aggregation engine 412 may provide the aggregated event information to correlation analysis engine 414 and/or to history database 419.

The correlation analysis engine 414 receives the aggregated event information (e.g., from aggregation engine 412 and/or from history database 419) and performs correlation of the aggregated events. The correlation analysis engine 414 may perform any suitable correlation functions. For example, related events 402 may be correlated and analyzed to determine the existence (or non-existence) of service affecting network conditions, events 402 may be correlated against the alert conditions based on temporal and/or spatial relativity, and the like, as well as various combinations thereof. The correlation analysis engine 414 may provide the correlated event information to processing engine 416 and/or to history database 419.

The processing engine 416 receives the policy/constraint information 404 and receives the correlated event information (e.g., from correlation analysis engine 414 and/or from history database 419).

The processing engine 416 generates a Reliability Integrity Meter (RIM) 422 which may include a summary of the information that is monitored, aggregated, and correlated by ME 124. The processing engine 416 may store RIM 422 locally (e.g., in history DB 419) and/or may provide RIM 422 to any suitable system, device, engine, and/or other component or element.

The processing engine 416 generates reactive/predictive control information 424. The ME 426 provides the reactive/predictive control information 424 to CE 127 for use by CE 127 in performing control functions within the physical infrastructure of automatic migration system 100. For example, ME 124 provides (1) reactive control information to CE 127 for use by one or more reactive control engines of CE 127 to provide reactive control functions within the physical infrastructure automatic migration system 100 and (2) predictive prevention control information to CE 127 for use by one or more predictive preventive control engines of CE 127 to provide predictive preventative control functions within the physical infrastructure automatic migration system 100.

The processing engine 416 may be configured to calculate various types of performance metrics (e.g., key quality indicators (KQIs), key performance indicators (KPIs), and the like), from raw data collected by ME 124. The metrics may be calculated for inclusion in the RIM 422. For example, performance metrics that may be used for reliability metering may include one or more of failure frequency (e.g., at the service level, component level, or any other suitable level) for hardware and/or software, downtime (e.g., at the service level, component level, or any other suitable level) for hardware and/or software, availability (e.g., at the service level, component level, or any other suitable level) for hardware and/or software, data unavailability (e.g., due to failures, security attacks, and the like), and the like, as well as various combinations thereof. It is noted that metrics may be specified at any suitable level (e.g., for a virtualized application or component, for a set of virtualized applications or components, for a service, for a set of services, for an end-to-end solution, for a datacenter, and the like, as well as various combinations thereof). It is noted that the performance indicators may be those that are most relevant to the customer under consideration. The processing engine 416 also may be configured to compare the performance indicators with expected values.

As further depicted in FIG. 4, CE 127 is configured to receive the reactive/predictive control information 424 from ME 124 and to use the reactive/predictive control information 424 to perform reactive/predictive control functions within the physical infrastructure automatic migration system 100. The CE 127 may provide the reactive control functions and the predictive preventative control functions by providing associated feedback actions into the physical infrastructure (e.g., feedback actions). It is noted that, whereas ME 124 observes and measures the behavior of the automatic migration system 100, CE 127 closes the loop to ensure that the measured behavior matches the expected behavior and, further, if there is a deviation, then appropriate corrective action is initiated. It is further noted that ME 124 performs functions and produces results that ultimately drive the control actions performed by CE 127 (e.g., the ME 124 combines the results of correlation analysis engine 414 with the policy/constraint information 404 and produces metrics included within the RIM 422, saves the results and current state as historical information within history database 419, and uses the policy/constraint information 404 and the historical information to drive the reactive and predictive preventative control actions performed by CE 127).

The CE 127 includes a reactive control engine 432 and a predictive preventative control engine 434.

The reactive control engine 432 receives reactive control information from ME 124 and performs reactive control functions within the physical infrastructure. The reactive control engine 432 may be configured to respond with an action to recover from a condition (e.g., an event, a failure, and the like). For example, recovery actions may include performing a process restart, performing a processor reboot and process restart on another processor (e.g., local or remote), reestablishing a failed network connection, performing a restart on a storage unit, performing recovery actions related to soft failures (e.g., re-initialization of data, restoration or resetting of a process, and the like), and the like, as well as various combinations thereof. The reactive control engine 432 may be configured to run a diagnostic test in order to identify the source or root cause of a condition.

The predictive preventative control engine 434 receives predictive preventative control information from ME 124 and performs predictive preventative control functions within the physical infrastructure. The predictive preventative control engine 434 may be configured to perform predictive preventative measures such as performing reorganizations, performing rebalancing actions, performing audits, performing proactive testing, and the like.

For example, predictive preventative control engine 434 may be configured to reorganize resources (e.g., a dynamic model construction as new services are composed or due to the recent events occurring in the system, a re-composition that changes the structure of the existing composite service, and the like).

For example, predictive preventative control engine 434 may be configured to perform defragmentation (e.g., by periodically defragmenting a storage system to make the disk accesses smoother and more efficient, thereby improving performance and conserving disk life time).

For example, predictive preventative control engine 434 may be configured to perform dynamic reliability modeling in which dynamic reliability computations are based on incremental updating of failure data. In one embodiment, the focus of dynamic reliability modeling is on the entire process from runtime data collection to reliability evaluation, with an emphasis on data collection and dynamic profiling instead of only using historical data. In one embodiment, the RIM 422 may be dynamically updated as the software is re-composed to meet the changing environment of automatic migration system 100.

For example, predictive preventative control engine 434 may be configured to perform re-balancing operations (e.g., by re-balancing the load on the available resources subject to the policy/constraint information 404).

For example, predictive preventative control engine 434 may be configured to perform audits. In one embodiment, periodic audits are performed to track physical and logical resources, maintain data integrity, and ensure security. In one embodiment, an audit may be performed on (1) resource inventory (e.g., CPU, memory, I/O, and network resources) and (2) topology of the infrastructure (e.g., connectivity between components including the redundancy configurations). In one embodiment, an audit is performed on the user databases and files to ensure data integrity and uncover any potential problems.

For example, predictive preventative control engine 434 may be configured to perform proactive testing. In one embodiment, proactive testing may include performing in-service simulated attacks, brink-of-failure condition testing, and testing related to planned maintenance actions (e.g., unplugging). In one embodiment, at least a portion of such proactive testing may rely on availability of virtually infinite resources in the physical infrastructure. This type of testing may help to ensure that the automatic migration system 100 continues to be robust.

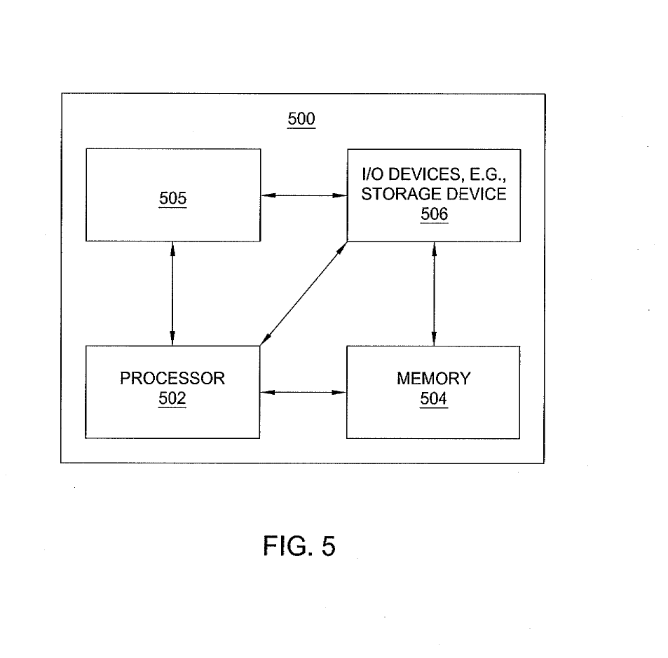

FIG. 5 depicts a high-level block diagram of a computing device suitable for use in implementing various functions described herein.

As depicted in FIG. 5, computer 500 includes a processor element 502, (e.g., 120, a central processing unit (CPU) and/or other suitable processor(s)), a memory 504 (e.g., 123, random access memory (RAM), read only memory (ROM), and the like), a cooperating module/process 505, and various input/output devices 506 (e.g., 121, a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents. In one embodiment, the various processes 505 may be loaded into memory 504 and executed by processor 502 to implement the functions as discussed herein. Thus, various processes 505 (including associated data structures) may be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions.

Although various embodiments which incorporate the teachings of the present invention have been shown and described in detail herein, those skilled in the art may readily devise many other varied embodiments that still incorporate these teachings.

What is claimed is:

1. A method for managing application services sessions for data center (DC) hosted applications provided to one or more user via a communications network, the method comprising:
determining, using DC management information and communications network management information, whether a user quality of experience (QoE) associated with the application services session is below a threshold level; and
in the case of said QoE being below said threshold level, selecting a new DC and migrating the application services session of at least one user to the new DC.

2. The method of claim 1, wherein files associated with the applications comprise working file set.

3. The method of claim 1, wherein QoE comprise latency, congestion, BW.

4. The method of claim 1, wherein network management information comprise latency, loss, bandwidth, security, congestion, scheduled maintenance.

5. The method of claim 1, wherein data center management information comprise CPU allocation, storage, working memory allocation, service location and security.

6. The method of claim 1, wherein the user session is a virtual desktop session.

7. The method of claim 1, further comprising:
improving migration of the user session based on user's access pattern and learning which data blocks are most used by the users.

8. An apparatus for managing application services sessions for data center (DC) hosted applications provided to one or more user via a communications network, the apparatus comprising:
a memory; and
a processor adapted to perform a plurality of user session migration functions, the user session migration functions adapted to:
determine, using DC management information and communications network management information, whether a user quality of experience (QoE) associated with the application services session is below a threshold level; and
in the case of said QoE being below said threshold level, select a new DC and migrating the application services session of at least one user to the new DC.

9. The apparatus of claim 8, wherein files associated with the applications comprise working file set.

10. The apparatus of claim 8, wherein QoE comprise latency, congestion, BW.

11. The apparatus of claim 8, wherein network management information comprise latency, loss, bandwidth, security, congestion, scheduled maintenance.

12. The apparatus of claim 8, wherein data center management information comprise CPU allocation, storage, working memory allocation, service location and security.

13. The apparatus of claim 8, wherein the user session is a virtual desktop session.

14. The apparatus of claim 8, further comprising:
improving migration of the user session based on user's access pattern and learning which data blocks are most used by the users.

15. A computer readable medium including software instructions which, when executed by a processer, adapt the processor to perform a method for managing application services sessions for data center (DC) hosted applications provided to one or more user via a communications network, the method comprising:
determining, using DC management information and communications network management information, whether a user quality of experience (QoE) associated with the application services session is below a threshold level; and
in the case of said QoE being below said threshold level, selecting a new DC and migrating the application services session of at least one user to the new DC.

16. A system for managing application services sessions for data center (DC) hosted applications provided to one or more user via a communications network, the system comprising:
an application agreement center node;
a data center;
a network operation center, wherein the application agreement center node communicates with the data center and the network operation center to thereby determine the most efficient location to run the virtual desktop of the user using the plurality of input parameters to dynamically migrate the user session to the identified location.
